(19) United States
(12) Patent Application Publication
(10) Pub. No.: US 2009/0199153 A1
(43) Pub. Date: Aug. 6, 2009

(54) EXPOSURE CONDITION SETTING METHOD AND PROGRAM FOR SETTING EXPOSURE CONDITIONS

(76) Inventors: Satoshi USUI, Oita-shi (JP); Satoshi TANAKA, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/363,058

(22) Filed: Jan. 30, 2009

(30) Foreign Application Priority Data
Jan. 31, 2008 (JP) 2008-021405

(51) Int. Cl. G06F 17/50

(52) U.S. Cl. 716/21

(57) ABSTRACT

There is provided an exposure condition setting method concerning an example of the present invention, the method includes inputting design layout data, extracting a plurality of design patterns having a predetermined dimension from the input design layout data, obtaining a transfer pattern transferred to a transfer target film by exposure of a mask pattern from the mask pattern associated with the extracted patterns, and calculating a dimensional fluctuation amount of the transfer pattern and a design value of the design pattern, obtaining a distribution of the number of the extracted design patterns associated with the dimensional fluctuation amount of the extracted design pattern, and setting exposure conditions in such a manner that the dimensional fluctuation amount of the extracted design pattern associated with a reference value in the distribution of the number of design patterns satisfies allowance conditions.

### CROSS-REFERENCE TO RELATED APPLICATIONS

This application is based upon and claims the benefit of priority from prior Japanese Patent Application No. 2008-021405, filed Jan. 31, 2008, the entire contents of which are incorporated herein by reference.

### BACKGROUND OF THE INVENTION

1. Field of the Invention

The present invention relates to an exposure condition setting method, and more particularly to a method and a program that set an exposure amount with respect to a gate pattern of a transistor.

2. Description of the Related Art

In recent years, to reduce a size of a semiconductor chip and increase a memory capacity of a memory chip, miniaturization of a semiconductor integrated circuit has been demanded. With this demand, an influence on pattern transfer due to an optical proximity effect is increased, assuring a sufficient process margin with respect to a fine pattern in a chip becomes difficult, and a production yield of a semiconductor integrated circuit tends to be lowered (see, e.g., Jpn. Pat. Appln. KOKAI Publication No. 2006-53248).

In particular, in a logic circuit element that is formed in a semiconductor integrated circuit, when circuit design differs in accordance with each product, such as an application-specific integrated circuit (ASIC), a size of a minimum pattern, an interval between patterns, and others also vary in accordance with each design layout. Therefore, process conditions enabling assurance of a sufficient process margin must be checked in accordance with each product.

Further, for example, in a semiconductor memory like a flash memory or a dynamic random access memory (DRAM), a memory cell array element is also mounted in the same chip as the logic circuit element. This memory cell array element is different from a pattern of the logic circuit element. For example, in a flash memory, designing is carried out by using a pattern having a specific cycle called “line and space”. Therefore, an error of a pattern size due to the optical proximity effect differs depending on the logic circuit element and the memory cell array element, and hence appropriate exposure conditions for each region also differ.

Accordingly, for such a semiconductor memory, setting appropriate exposure conditions enabling assurance of a sufficient process margin in both the logic circuit element and the memory cell array element is difficult, which is one of factors that reduce a production yield of a semiconductor integrated circuit.

### BRIEF SUMMARY OF THE INVENTION

There is provided an exposure condition setting method concerning an example of the present invention, comprising: inputting design layout data; extracting a plurality of design patterns having a predetermined dimension from the input design layout data; obtaining a transfer pattern transferred to a transfer target film by exposure of a mask pattern from the mask pattern associated with the extracted patterns, and calculating a dimensional fluctuation amount of the transfer pattern and a design value of the design pattern; obtaining a distribution of the number of the extracted design patterns associated with the dimensional fluctuation amount of the extracted design pattern; and setting exposure conditions in such a manner that the dimensional fluctuation amount of the extracted design pattern associated with a reference value in the distribution of the number of design patterns satisfies allowance conditions.

There is provided an exposure condition setting method concerning an example of the present invention, comprising: inputting design layout data; extracting a plurality of design patterns having a predetermined dimension from the input design layout data; obtaining a transfer pattern transferred to a transfer target film by exposing a mask pattern associated with the extracted layout pattern; verifying an operation of a circuit pattern associated with the transfer pattern in accordance with each exposure amount by using a dimensional fluctuation amount of a corresponding inter-pattern space for each of different design patterns used in the design layout data; and setting exposure conditions to satisfy operation allowance conditions based on a result of the verification.

There is provided a program for setting exposure conditions concerning an example of the present invention, comprising: inputting design layout data; extracting a plurality of design patterns having a predetermined dimension from the input design layout data; obtaining a transfer pattern transferred to a transfer target film by exposure of a mask pattern from the mask pattern associated with the extracted patterns, and calculating a dimensional fluctuation amount of the transfer pattern and a design value of the design pattern; obtaining a distribution of the number of extracted design patterns associated with the dimensional fluctuation amount of the extracted design pattern; and setting exposure conditions in such a manner that the dimensional fluctuation amount of the extracted design pattern associated with a reference value in the distribution of the number of the design patterns satisfies allowance conditions.

### BRIEF DESCRIPTION OF THE SEVERAL VIEWS OF THE DRAWING

FIG. 1 is a step diagram showing a processing flow of an exposure condition setting method according to a first embodiment;

FIG. 2 is a block diagram showing a system that executes the processing flow depicted in FIG. 1;

FIG. 3 is a schematic view for explaining a gate pattern according to the first embodiment;

FIG. 4 is a view showing an example of a gate length distribution with respect to an inter-pattern space;

FIG. 5 is a view showing an example of a fluctuation amount of an error with respect to the inter-pattern space;

FIG. 6 is a view showing an example of a gate length distribution with respect to an error;

FIG. 7 is a view schematically showing a layout change using a reference cell;

FIG. 8 is a step diagram showing a processing flow of an exposure condition setting method according to a second embodiment;

FIG. 9 is a view showing an example of a fluctuation amount of an error with respect to an inter-pattern space;

FIG. 10 is a schematic view for explaining the second embodiment; and

FIG. 11 is a step diagram for explaining an application.

### DETAILED DESCRIPTION OF THE INVENTION

A plurality of modes that carry out an example of the present invention will now be explained hereinafter in detail with reference to the drawings.

### 1. Outline

An embodiment according to the present invention relates to an exposure condition setting method, and more particularly to a method and a program that set exposure conditions with respect to a gate pattern. Moreover, the present invention relates to a pattern data creating method that design a pattern based on the set exposure conditions.

The exposure condition setting method and program according to the embodiment of the present invention execute correction processing such as optical proximity correction (OPC) with respect to a gate pattern (a design pattern) of a MOS transistor in input design layout data, thereby forming a mask pattern. Additionally, an exposure amount is calculated from a dimensional fluctuation amount obtained from a pattern transferred when exposing the formed mask pattern and a distribution of the number of gate lengths that are in heavy use in the design layout. The obtained exposure amount is set as a value that is suitable for use in transfer of a pattern based on exposure.

As a result, an exposure amount enabling assurance of a sufficient process margin can be easily set with respect to a circuit element whose design layout differs depending on each product.

Further, in the embodiment according to the present invention, an operation of a logic circuit element is verified based on simulation under a plurality of exposure amount conditions based on an OP error in a gate pattern of a MOS transistor in input design layout data. Furthermore, an exposure amount enabling compensation for an operation of the logic circuit element is set as an exposure amount suitable for use in transfer of a pattern based on exposure. As a result, an exposure amount enabling compensation for an operation can be easily set with respect to the logic circuit element whose design layout differs depending on each product.

Moreover, when a memory cell array element is formed on the same chip as the logic circuit element, one item of design layout data is selected from a plurality of items of design layout data of the memory cell array element for respective previously designed exposure amounts based on an exposure amount set with respect to the logic circuit element. As a result, a sufficient process margin can be assured with respect to each of the logic circuit element and the memory cell array element under the same exposure conditions.

As explained above, according to the embodiment of the present invention, a production yield of a semiconductor integrated circuit can be improved.

### 2. Embodiments

### (1) First Embodiment

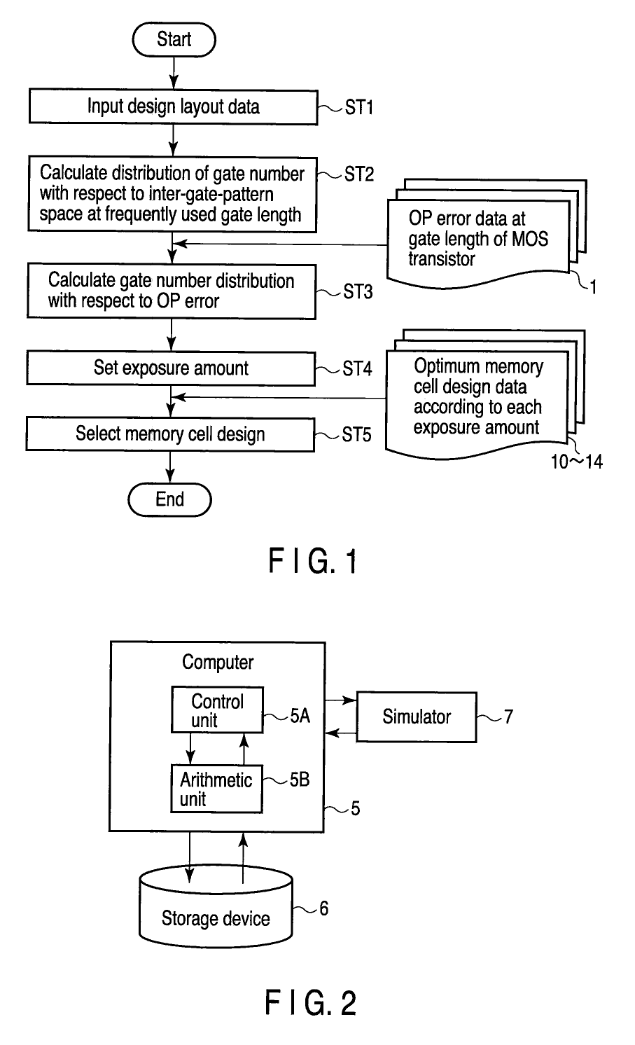

A first embodiment according to the present invention will now be explained with reference to FIGS. 1 to 7.

FIG. 1 is a view showing a processing flow of an exposure condition setting method according to this embodiment. Furthermore, FIG. 2 is a block diagram showing a basic structure of an apparatus that executes the processing flow depicted in FIG. 1. The apparatus depicted in FIG. 2 is an exposure condition setting apparatus and includes a computer 5, a storage device 6, and a simulator 7. The computer 5 has a control unit 5A and an arithmetic unit 5B. The control unit 5A has software required to execute processing depicted in FIG. 1 with respect to, e.g., design layout data input to the arithmetic unit 5B, and allows the arithmetic unit 5B to execute this processing. The simulator 7 executes simulation with respect to the input design layout data.

In this embodiment, the processing flow depicted in FIG. 1 is processed as follows by using the exposure condition setting apparatus depicted in FIG. 2.

First, design layout data of a product to be manufactured is input to the arithmetic unit 5B of the computer 5 (ST1). The design layout data includes, e.g., a plurality of design patterns associated with respective manufacturing steps for formation of a MOS transistor in a logic circuit element (first circuit element). The design pattern mainly used in the processing according to this embodiment is pattern data corresponding to a gate pattern of the MOS transistor.

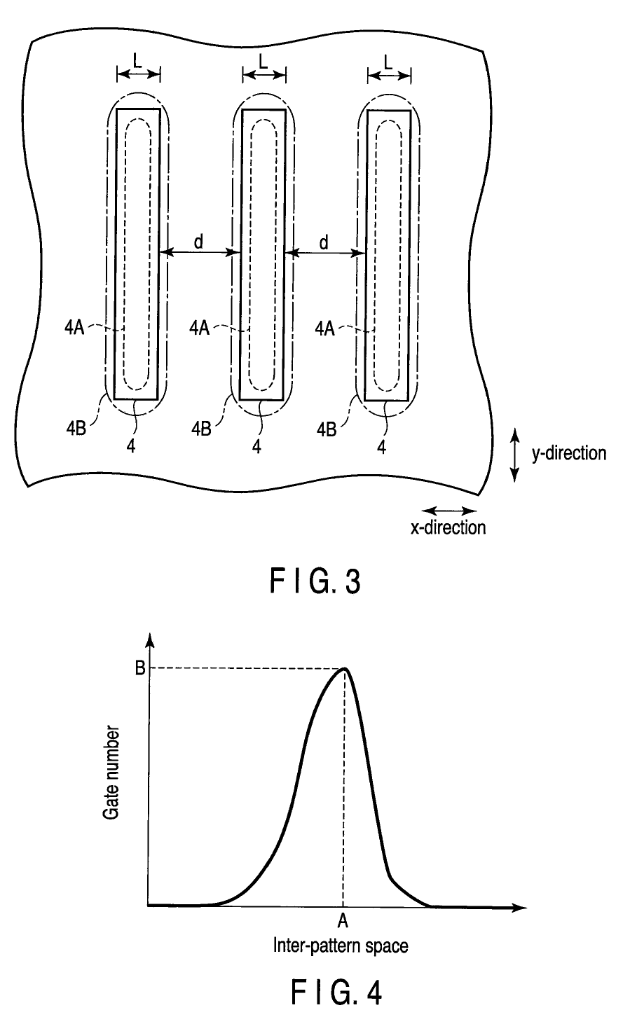

Here, the gate pattern of the MOS transistor in the design layout data will now be explained with reference to FIG. 3. FIG. 3 is a schematic view showing gate patterns of a plurality of MOS transistors arranged to be adjacent to each other in an x-direction in the design layout data.

The plurality of MOS transistors are designed with different gate lengths L in accordance with characteristics required for a plurality of circuits/gates in a logic circuit element constituting a semiconductor chip. Furthermore, the gate patterns of the plurality of MOS transistors have intervals d between the different gate patterns (referred to as inter-pattern spaces hereinafter) in accordance with a layout of the logic circuit element, and they are arranged to be adjacent to each other in an x-y plane. It should be noted that FIG. 3 shows an example where gate patterns having the same gate length L are arranged with the same inter-pattern space d for convenience of explanation.

Moreover, a pattern 4A indicated by a broken line in FIG. 3 shows an example of a gate pattern that is transferred to a transfer target film when an exposure amount is large, and a pattern 4B indicated by an alternate long and short dash line in FIG. 3 shows an example of a transfer pattern of the gate pattern that is transferred to the transfer target film when an exposure amount is small. A pattern transferred to the transfer target film using a mask pattern like the patterns 4A and 4B in FIG. 3 will be referred to as a transfer pattern hereinafter. The mask pattern is created based on the input design layout data. As shown in FIG. 3, when an exposure amount is large, the transfer pattern 4A is formed to be smaller than the designed gate pattern 4. On the other hand, when an exposure amount is small, the transfer pattern 4B is formed to be larger than the designed gate pattern 4. In this embodiment, a displacement amount (dimensional fluctuation amount) of sizes of this designed gate pattern 4 and the transfer pattern 4A or 4B will be explained as an OP(optical proximity) error. As one of factors of occurrence of the OP error, there is, e.g., mutual interference of neighboring patterns caused due to a size of an inter-pattern space.

After the design layout data is input, the control unit 5A in the computer 5 extracts a gate length that is in heavy use in a plurality of respectively set gate lengths in the gate patterns of the MOS transistors in the logic circuit element in this input data. Extraction of this gate length is executed by, e.g., acquiring design information of the MOS transistors included in the design layout data or checking some of the gate patterns in the design layout data by the computer 5. It should be noted that the extracted gate length is, e.g., the most frequently used gate length in the gate patterns in the design layout.

Moreover, in the gate patterns having the gate length that is in heavy use, the computer 5 identifies each interval between the patterns adjacent to each other. As a result, as shown in FIG. 4, the computer 5 calculates such a distribution of the gate number with respect to the inter-pattern space at the gate length that is in heavy use (ST2). This calculation result is stored in, e.g., the storage device 6 as data.

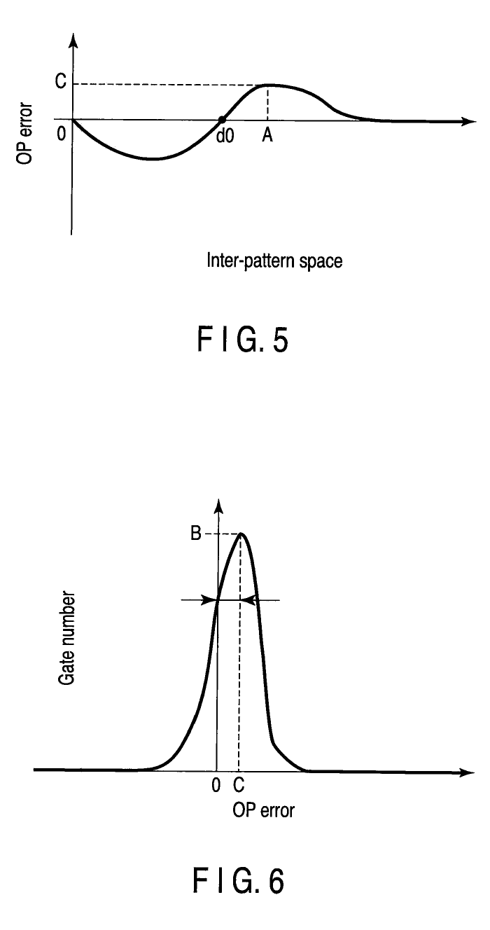

Additionally, in this embodiment, an OP error (dimensional fluctuation amount) for the inter-pattern space is previously calculated based on, e.g., an experiment or lithography simulation using the simulator 7 with respect to each of all the gate lengths used for the MOS transistors in the design layout data. Further, such data of the OP error for the inter-pattern space as shown in FIG. 5 is created in accordance with each gate length, and this data is stored in the storage device 6 as a database.

FIG. 5 shows an example of data of a fluctuation amount of the OP error for the inter-pattern space in the MOS transistor having an arbitrary gate length. In the example depicted in FIG. 5, the OP error is zero when the inter-pattern space is d0, the OP error indicates a negative value when the inter-pattern space is smaller than d0, and the OP error indicates a positive value when the inter-pattern space is larger than d0. It should to be noted that a tendency of fluctuation in the OP error for the inter-pattern space of course differs in accordance with each gate length to be used.

Furthermore, in regard to exposure conditions set by the lithography simulation, simulation may be carried out based on one arbitrary condition, but simulation may be performed while changing an exposure amount in accordance with each gate length, and a simulation result of each exposure amount may be compiled to form a database and then stored in the storage device 6.

Moreover, as shown in FIG. 1, the computer 5 acquires from the storage device 6 data of a fluctuation amount associated with a gate length frequently used in the logic circuit element from the plurality of items of data 1 indicative of fluctuations of the OP error for inter-pattern spaces. Additionally, the acquired data 1 and the data of a distribution of the number of gates with respect to each inter-pattern space created at the step ST2 are data with respect to the inter-pattern spaces for the same gate length. Therefore, a distribution of the gate number with respect to the OP error is calculated by combining data for a fluctuation amount and data of the distribution of the gate number (ST3). This calculation result represents a distribution of the gate number with respect to the OP error as shown in FIG. 6, for example. An exposure amount with which the OP error becomes less than a tolerance or preferably zero with respect to a reference value of the distribution of the gate number is calculated based on such data of the distribution of the gate number with respect to the OP error. It should be noted that, as the reference value of the distribution of the gate number, a mode or a median of the gate is used.

For example, in distribution data of the gate number with respect to the inter-pattern space depicted in FIG. 4, distributions when the inter-pattern space is “A” belong to the largest group, and this is a mode “B” of the gate number. Moreover, in data of a fluctuation amount of the OP error with respect to the inter-pattern space depicted in FIG. 5, when the inter-pattern space is A, the OP error is “C”.

Therefore, as shown in FIG. 6, in regard to an arbitrary exposure amount at the time of creating data of a fluctuation amount of the OP error with respect to the inter-pattern space depicted in FIG. 5, when the OP error is “C”, a gate length that is frequently used in the logic circuit element represents a mode.

Additionally, the arithmetic unit 5B in the computer 5 calculates an exposure amount with which the OP error becomes less than a tolerance or preferably zero when the gate number is the mode from a displacement amount Z of the OP error “0” and the OP error “C” based on FIG. 6. It should be noted that the exposure amount to be calculated may be an exposure amount that becomes a minimum value in distribution data used for calculation. This calculated exposure amount is set as an exposure amount that is optimum for the logic circuit element. That is, according to this embodiment, in gate patterns of the MOS transistors in the logic circuit element, an exposure amount calculated in such a manner that an OP error (dimension fluctuation amount) becomes small with respect to a frequently used gate length and a frequently used inter-pattern space is set as an exposure amount suitable for the entire logic circuit element. It should be noted that this embodiment has been explained while taking a mode of the gate number distribution as an example, but an exposure amount with which an OP error becomes less than a tolerance with a median of the gate number distribution may be calculated and set as an exposure amount suitable for transfer based on exposure. It should be noted that the median means a value of the gate number that is in the center of inter-pattern space in this embodiment.

Additionally, when data of a fluctuation amount of an OP error with respect to an inter-pattern space is created based on simulation in which an exposure amount is changed in accordance with each gate length, an exposure amount with which the OP error becomes less than a tolerance or preferably zero with a mode or a median of a gate number may be obtained by sequentially making reference to the created data and distribution data of the gate number for the inter-pattern space.

As explained above, an exposure amount with which an OP error becomes less than a tolerance with a mode or a median of a gate number is calculated from distribution data of the gate number at a gate length that is frequently used with respect to a fluctuation amount of the OP error, and it is set as an appropriate exposure amount with respect to the logic circuit element.

As a result, in the logic circuit element whose design layout differs depending on each product, an appropriate exposure amount enabling assurance of a sufficient process margin can be easily obtained.

Additionally, like an example where the logic circuit element having a set exposure amount is a circuit that controls the memory cell array element (second circuit element), when the logic circuit element and the memory cell array element are formed on the same chip, the following processing is further executed.

In this embodiment, design layout data of the memory cell array element that is appropriate for each different exposure amount is created by a previously conducted experiment or simulation.

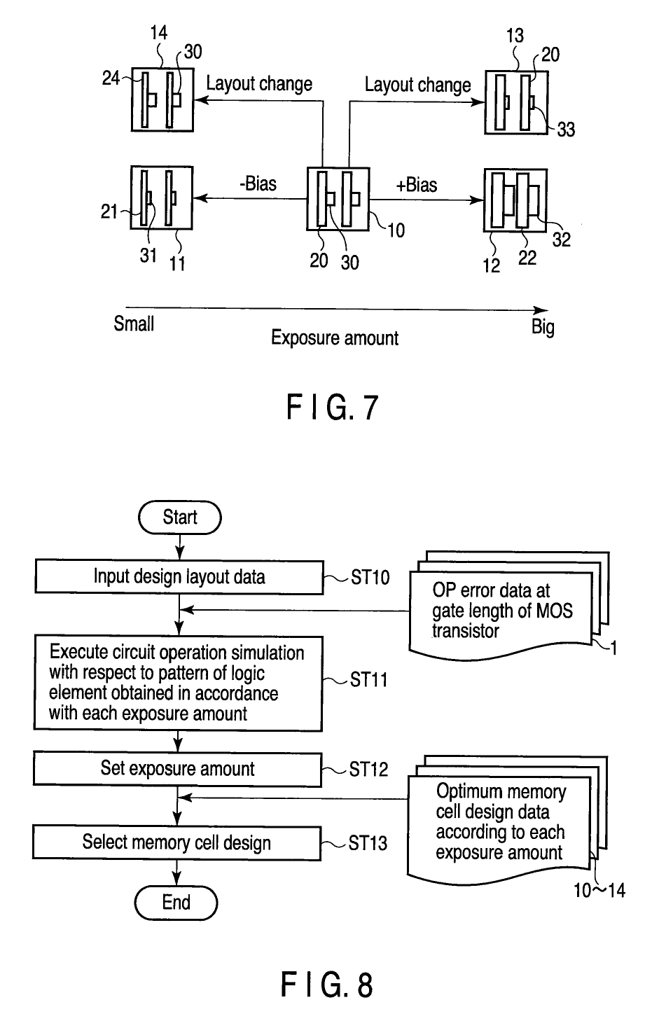

As shown in FIG. 7, reference memory cell design data 10 (referred to as reference cell design data hereinafter) is created as design layout data of the memory cell array element (referred to as memory cell design data hereinafter). Further, bias processing or layout change for each exposure amount is executed with respect to a graphic pattern 20 or 30 in the reference cell design data, and items of memory cell design data 11 to 14 for respective exposure amounts are created in such a manner that the same pattern as a reference cell design can be formed on a blanks substrate or a chip (a semiconductor substrate) even if an exposure amount varies. These items of memory cell design data 10 to 14 are stored in the storage device 6 as a database.

It should be noted that the bias processing for a pattern means processing of reducing (negative bias) dimensions of all the graphic patterns 20 and 30 in the reference memory cell design data 10 like patterns 21 and 31 in accordance with an exposure amount or processing of increasing (positive bias) the same like patterns 22 and 32 in the memory cell design data 12. Furthermore, the layout change means partial bias processing for a given graphic pattern, and it is processing of increasing/decreasing a dimension of a part of patterns in the memory cell design data 10. It is, e.g., processing of changing a dimension of the pattern 30 alone in the memory cell design data 10 like a pattern 33 in the memory cell design data 13 or processing of changing a dimension of the pattern 20 alone in the memory cell design data 10 like a pattern 24 in the memory cell design data 14.

The computer 5 selects one item of memory cell design data suitable for an exposure amount of the logic circuit element set at the step ST4 from these items of memory cell design data 10 to 14 for the respective exposure amounts, and the memory cell design data in the original design layout data is changed (ST5). As a result, a common exposure amount is set with respect to the memory cell array element and the logic circuit element formed on the same chip. It should be noted that a process margin assured under exposure conditions which are common to the logic circuit element and the memory cell array element is called a common margin in the embodiment according to the present invention.

For example, when the memory cell array element is formed of a specific cycle pattern such as a line-and-space pattern like a flash memory, this pattern is simpler than that of the logic circuit element, and hence the pattern can be relatively easily changed. Therefore, after an exposure amount of the logic circuit element is set, the bias processing or the layout change may be carried out with respect to the reference memory cell design data based on this exposure amount as required to create memory cell design data for the set exposure amount.

As explained above, according to the first embodiment of the present invention, in regard to a gate length that is frequently used in gate patterns of the MOS transistors in the logic circuit element, data of a gate number distribution with respect to an inter-pattern space is combined with data of a fluctuation amount of an OP error with respect to the inter-pattern space so that an exposure amount with which the OP error becomes less than a tolerance with respect to the logic circuit is set as an exposure amount used for exposure of the patterns.

Therefore, in the logic circuit element whose design layout data differs depending on each product, an appropriate exposure amount enabling assurance of a sufficient process margin can be easily obtained.

Moreover, when the logic circuit element and the memory cell array element are formed on the same chip, one item of memory cell design data is selected based on the exposure amount set with respect to the logic circuit element from a plurality of items of memory cell design data which are designed in advance to become appropriate for respective exposure amounts. Therefore, design data of memory cells suitable for the set exposure amount is created. Accordingly, a common margin can be assured with respect to each of the logic circuit element and the memory cell array element.

Therefore, according to the first embodiment of the present invention, a sufficient process margin can be assured, and a production yield of a semiconductor integrated circuit can be improved.

It should be noted that the description has been given as to the method of calculating an exposure amount by utilizing databases stored in the storage device 6 in this embodiment, but a distribution of a gate number with respect to an OP error may be directly calculated based on simulation using the simulator 7 to obtain an exposure amount.

Additionally, although the exposure conditions have been explained as the exposure amount in this embodiment, the exposure conditions may be other conditions that affects a shape of an exposure pattern, e.g., focusing, an aberration, an illumination shape, and others of the exposure device, and these conditions may be combined.

### (2) Second Embodiment

In the first embodiment of the present invention, the example of assuring a process margin for the logic circuit element and a common margin for the logic circuit element and the memory cell array element has been explained.

In the logic circuit element, a fact that a predetermined operation cannot be executed due to a fluctuation in pattern dimension due to an optical proximity effect becomes a serious problem. For example, when a design pattern dimension fluctuates, a resistance value or a parasitic capacitance of an interconnect varies with a change in an interconnect width and an interconnect pitch, whereby a driving voltage or an operation timing of a semiconductor integrated circuit may be affected. Therefore, both assuring a process margin and compensating for an operation of the semiconductor integrated circuit in which the logic circuit element is formed are important.

In a second embodiment of the present invention, an exposure condition setting method of setting an exposure amount enabling compensation of operation characteristics of a semiconductor integrated circuit and a pattern design method using this method will be explained. Here, an example of compensating for an operation clock of the logic circuit element will be described. It should be noted that a margin of an operation clock that is assured to operate the logic circuit element (semiconductor integrated circuit) at a predetermined timing will be referred to as a timing margin in this embodiment.

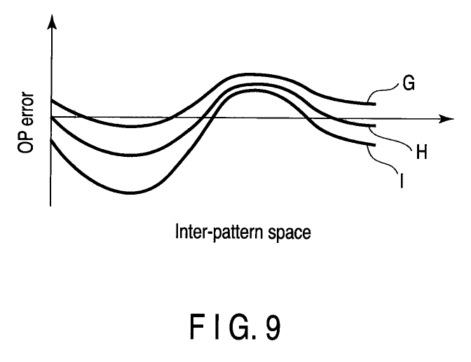

In the second embodiment according to the present invention, a method of setting an exposure amount enabling assurance of a timing margin for the logic circuit element will be explained with reference to FIGS. 8 and 9.

First, as shown in FIG. 8, like the first embodiment, design layout data is input to a computer 5 (ST10). In the logic circuit element, gate patterns of MOS transistors are designed by using a plurality of dimensions (gate lengths). Therefore, an experiment or simulation for each exposure amount is previously carried out with respect to all the gate lengths used in the gate patterns. Furthermore, data of a fluctuation amount of an OP error with respect to an inter-pattern space for each exposure amount at all the utilized gate lengths is created based on the experiment or simulation, and such data is stored in a storage device 6 as data 1.

FIG. 9 shows an example of data representing an OP error with respect to an inter-pattern space under arbitrary exposure conditions. As shown in FIG. 9, the data representing an OP error with respect to an inter-pattern space is data created with respect to each of different gate lengths G to I. Moreover, usually, when the gate length varies, the OP error with respect to the inter-pattern space also varies.

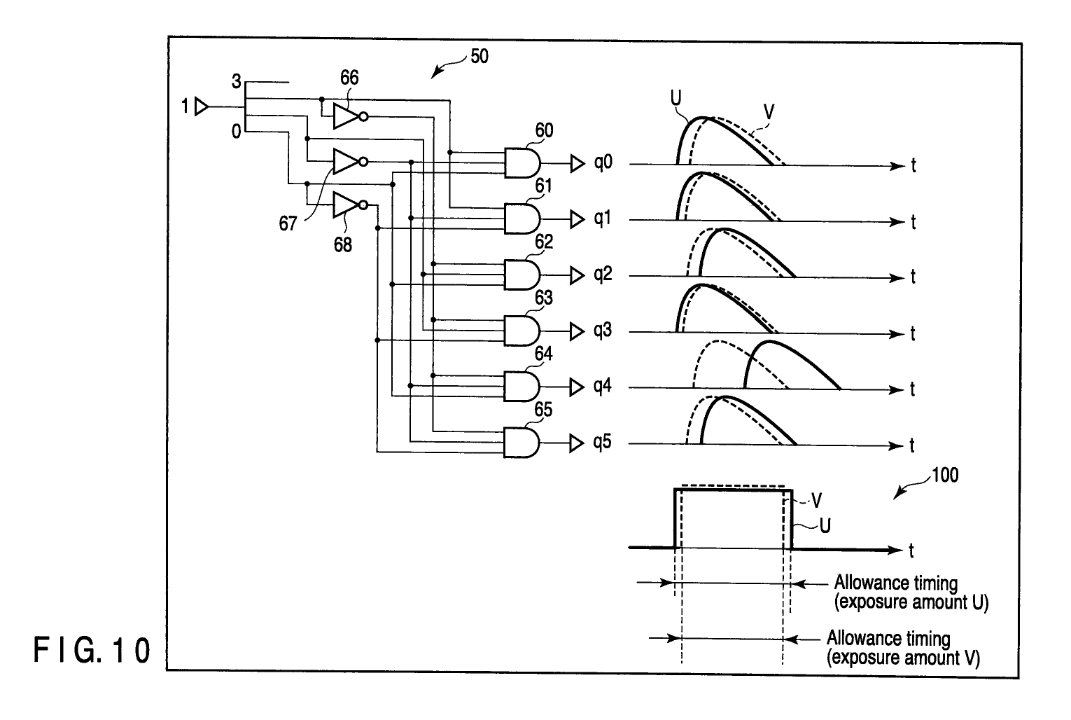

Then, circuit simulation is executed by using a simulator 7 with respect to circuit patterns for respective exposure amounts, i.e., patterns of the logic circuit element in the input design layout data including data of a fluctuation amount of the OP error with respect to the inter-pattern space depicted in FIG. 9. As a result, an operation of the logic circuit element in the gate patterns formed with different exposure amounts is verified. Verification of the operation of the logic circuit element in this embodiment will now be more specifically explained hereinafter with reference to FIG. 10.

FIG. 10 is a view schematically showing results of the circuit simulation executed based on FIGS. 8 and 9. FIG. 10 shows simulation results executed with two different exposure amounts U and V with respect to design layout data corresponding to a logic circuit 50 as an example. The circuit simulation is executed with respect to gate patterns of all MOS transistors constituting the logic circuit while considering a change in an OP error with respect to an inter-pattern space for each gate length.

The logic circuit 50 depicted in FIG. 10 is formed of three-input AND gates 60 to 65 and inverters 66 to 68. An input signal is input to each of the inverters 66 to 68.

An output signal from the inverters 66 is input to each of the four AND gates 62 to 65. An output signal from the inverter 67 is input to each of the four AND gates 60, 61, 64, and 65. An output signal from the inverter 68 is input to each of the three AND gates 61, 63, and 65.

Further, FIG. 10 shows waveforms of output signals q0 to q5 from the AND gates 60 to 65 with respect to a time t as an operation timing chart. It should be noted that a waveform 100 in FIG. 10 indicates a range of an allowance timing in accordance with each of exposure amounts U and V at a predetermined operation timing. In each waveform in FIG. 10, a solid line U indicates a result obtained when the exposure amount U is adopted and a broken line V indicates a result obtained when the exposure amount V is adopted.

When the exposure amount varies as explained above, a dimension of a transferred pattern is also increased or decreased. When a semiconductor integrated circuit is formed based on a pattern including such a change in dimension, a driving force of each MOS transistor or electrical characteristics of each interconnect, e.g., a resistance or a parasitic capacitance varies. As a result, as shown in FIG. 10, an operation clock of the semiconductor integrated circuit differs depending on each exposure amount even though an output from the same element is used.

In the example depicted in FIG. 10, a timing of the output signal q4 greatly deviates from the allowance timing in a circuit simulation result based on the exposure amount U. Therefore, in a gate pattern formed with the exposure amount U, a timing margin of the logic circuit 50 cannot be assured.

On the other hand, each of the output signals q0 to q5 has a small error with respect to the allowance timing set for the predetermined operation timing in a circuit simulation result based on the exposure amount V, and a timing margin sufficient to operation the semiconductor integrated circuit having the logic circuit element formed therein can be assured. Therefore, the exposure amount V is set as an exposure amount suitable for the logic circuit element.

As a result, in the logic circuit element whose design layout differs depending on each product, an exposure amount enabling assurance of a sufficient timing margin can be easily obtained. It should be noted that the simulation results based on the two different exposure amounts are illustrated in this embodiment for convenience of explanation, but the present invention is not restricted thereto, and simulation may be carried out based on three or more exposure amounts.

Further, when the memory cell array element is formed on the same chip as the logic circuit element, like the first embodiment, one item of data suitable for an exposure amount used for the logic circuit element is selected from a plurality of items of memory cell design data 10 to 14 provided for respective exposure amounts, thereby creating design layout data for memory cell array elements (ST13).

As explained above, in the second embodiment according to the present invention, in regard to all gate lengths of MOS transistors used in the logic circuit element, circuit simulation for a gate pattern formed in accordance with each exposure amount including OP error data for each inter-pattern space is executed. Based on simulation results, exposure conditions of the logic circuit element enabling assurance of a timing margin are set.

As a result, in the logic circuit element whose design layout data differs depending on each product, an exposure amount enabling assurance of a sufficient timing margin can be readily obtained.

Furthermore, when the logic circuit element and the memory cell array element are formed on the same chip, a layout of the memory cell array element that is suitable for exposure amount conditions set with respect to the logic circuit element is selected from a plurality of items of design layout data of the memory cell array element designed for respective exposure amounts. Therefore, a common margin can be assured for each of the logic circuit element and the memory cell array element.

Thus, according to the second embodiment of the present invention, a timing margin of the logic circuit element can be assured, and a sufficient process margin can be assured for each of the logic circuit element and the memory cell array element, thereby improving a production yield of the semiconductor integrated circuit.

It should be noted that an operation clock of the logic circuit element is verified in the second embodiment according to the present invention, but the present invention is not restricted thereto, verification of an operation based on simulation may be carried out with respect to a driving voltage, RC delay, crosstalk noise, signal change noise, signal reflection noise, electromigration, electromagnetic interference (EMI), and others.

### (3) Third Embodiment

The first and second embodiments can be executed by the computer 5 depicted in FIG. 2 as, e.g., programs.

For example, the flow depicted in FIG. 1 is described as a program (software).

This program is held in, e.g., the control unit 5A in the computer 5. Alternatively, it is stored in a storage device (not shown) in the computer 5 or a storage device (not shown) provided outside the computer 5. It should be noted that the program stored in a recording medium may be provided to the computer and the computer may execute the program in the recording medium. Moreover, the program may be provided to the computer through a communication line.

When executing a program associated with the flow depicted in FIG. 1, the computer 5 sets exposure conditions by the same operation as that explained in the first embodiment.

That is, based on the program, the computer 5 obtains the number of a gate length frequently utilized in a logic circuit element in input design layout data, and acquires data of a distribution of a gate number with respect to an inter-pattern space when this gate length is used (ST1, ST2).

Then, the computer 5 acquires data of a fluctuation amount of an OP error associated with the frequently utilized gate length from a plurality of items of data indicative of fluctuation amounts of OP errors of respective gate lengths obtained in advance. Additionally, the computer 5 combines the gate distribution data with the error fluctuation amount data to set an exposure amount utilized for the logic circuit element (ST3, ST4).

Further, when the design layout data includes data associated with the memory cell array element, the computer 5 creates design layout data associated with the memory cell array element based on the set exposure amount (ST5).

Furthermore, the flow depicted in FIG. 8 can be of course executed as a program. When executing a program corresponding to the flow depicted in FIG. 8, the computer 5 verifies an operation of the circuit associated with input design pattern data based on the same operation as that explained in the second embodiment.

That is, the computer 5 verifies an operation of each pattern of the circuit indicated by the input design pattern data while considering a change in OP error with respect to each inter-pattern space in regard to each of the gate lengths utilized in the input design layout data (ST10, ST11). Moreover, the computer 5 sets exposure conditions used for exposure based on a verification result (ST12).

As explained above, the computer can execute the exposure condition setting method concerning each of the first and second embodiments according to the present invention as a program.

It should be noted that the flows described in the first and second embodiments have been explained as the different programs here. However, when using the techniques described in the first and second embodiments as programs to set exposure conditions, these techniques may be continuously executed by the computer 5. For example, exposure conditions are once set by using the technique explained in the first embodiment. Then, the exposure conditions may be used to verify an operation of the circuit indicated by design layout data like the technique explained in the second embodiment, thereby adjusting the set exposure conditions. When executing the exposure condition setting methods according to the first and second embodiments as programs in this manner, suitable exposure conditions can be flexibly set.

### 3. Application

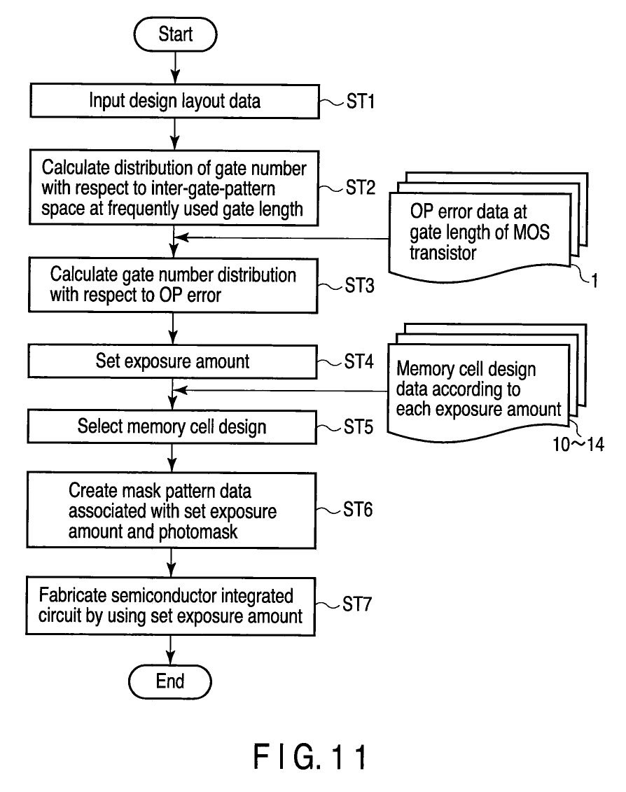

As shown in FIG. 11, the exposure condition setting method according to each embodiment of the present invention can be used for a photomask manufacturing method and a semiconductor integrated circuit manufacturing method.

That is, in the photomask manufacturing method, an appropriate exposure amount for design layout data is set based on the first or second embodiment according to the present invention. The set exposure amount is used to execute extraction of a process risk position where short circuit or disconnection may possibly occur in design layout data or OP processing for this extraction, thus creating mask pattern data associated with the design layout data. Additionally, a pattern is drawn on a blanks substrate based on this mask pattern data by electron beam exposure, thereby manufacturing a photomask (ST6).

Therefore, the photomask enabling transferring the mask pattern associated with the appropriate exposure amount onto a transfer target film on a chip (semiconductor substrate) can be fabricated.

Further, according to the semiconductor integrated circuit manufacturing method, a pattern of the thus fabricated photomask is transferred onto a transfer target film on a semiconductor substrate coated with a resist by using an exposure amount calculated based on the first or second embodiment according to the present invention. Furthermore, a conductive layer and an insulating layer formed on the semiconductor substrate are etched based on the transferred pattern, whereby elements such as MOS transistors are formed. As a result, a semiconductor integrated circuit is manufactured (ST7).

Therefore, the semiconductor integrated circuit can be fabricated based on an exposure amount enabling assurance of a process margin or an exposure amount enabling assurance of a timing margin.

Thus, according to the application of the embodiments of the present invention, a production yield of the semiconductor integrated circuit can be improved.

It should be noted that the photomask manufacturing method and the semiconductor integrated circuit manufacturing method have been explained as processes following the exposure condition setting method explained in the first embodiment, but a photomask or a semiconductor integrated circuit may be of course fabricated as a process following the exposure condition setting method described in the second embodiment.

### 4. Others

The embodiments according to the present invention can improve a production yield of a semiconductor device.

In the embodiments according to the present invention, although the first embodiment and the second embodiment have been explained as different examples, the first embodiment may be combined with the second embodiment to calculate an exposure amount enabling assurance of both a process margin and a timing margin of the logic circuit element.

The embodiments according to the present invention can be applied to the exposure condition setting method for a semiconductor integrated circuit in which design of a logic circuit element varies depending on each product like an ASIC.

Further, the embodiments according to the present invention can be applied to the exposure condition setting method for a semiconductor integrated circuit in which a memory cell array element and a logic circuit element are formed on the same chip like a flash memory or a DRAM.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An exposure condition setting method comprising:
inputting design layout data;
extracting a plurality of design patterns having a predetermined dimension from the input design layout data;
obtaining a transfer pattern transferred to a transfer target film by exposure of a mask pattern from the mask pattern associated with the extracted patterns, and calculating a dimensional fluctuation amount of the transfer pattern and a design value of the design pattern;
obtaining a distribution of the number of the extracted design patterns associated with the dimensional fluctuation amount of the extracted design pattern; and
setting exposure conditions in such a manner that the dimensional fluctuation amount of the extracted design pattern associated with a reference value in the distribution of the number of design patterns satisfies allowance conditions.

2. The method according to claim 1, wherein obtaining the distribution of the number of extracted design patterns associated with the dimensional fluctuation amount of the extracted design patter includes:
obtaining the distribution of the number of extracted design patterns in accordance with an inter-pattern space of the plurality of extracted design patterns adjacent to each other; and
obtaining the dimensional fluctuation amount of the extracted design pattern in accordance with the inter-pattern space of the design pattern.

3. The method according to claim 1, further comprising:
creating layout data associated with a second circuit element in the design layout data in accordance with the set exposure conditions when the design layout data includes data associated with a first circuit element and data associated with the second circuit element and the set exposure conditions are exposure conditions associated with the first circuit element.

4. The method according to claim 1, further comprising:
fabricating a semiconductor integrated circuit corresponding to the design layout data on a semiconductor substrate by using the set exposure conditions.

5. The method according to claim 1, wherein the design pattern is a gate pattern of a transistor and the gate pattern is extracted based on a gate length of the gate pattern.

6. The method according to claim 3, wherein the first circuit element is a logic circuit element and the second circuit element is a memory cell array element.

7. An exposure condition setting method comprising:
inputting design layout data;
extracting a plurality of design patterns having a predetermined dimension from the input design layout data;
obtaining a transfer pattern transferred to a transfer target film by exposing a mask pattern associated with the extracted layout pattern;
verifying an operation of a circuit pattern associated with the transfer pattern in accordance with each exposure amount by using a dimensional fluctuation amount of a corresponding inter-pattern space for each of different design patterns used in the design layout data; and
setting exposure conditions to satisfy operation allowance conditions based on a result of the verification.

8. The method according to claim 7, wherein, in the verification of the circuit operation, the exposure conditions are set in such a manner that at least one of a driving voltage, RC delay, crosstalk noise, signal change noise, signal reflection noise, electromigration, and electromagnetic interference of the circuit pattern satisfies the allowable conditions.

9. The method according to claim 7, further comprising:
creating layout data associated with a second circuit element in the design layout data in accordance with the set exposure conditions when the design layout data includes data associated with a first circuit element and data associated with the second circuit element and the set exposure conditions are exposure conditions associated with the first circuit element.

10. The method according to claim 7, further comprising:
fabricating a semiconductor integrated circuit corresponding to the design layout data on a semiconductor substrate by using the set exposure conditions.

11. The method according to claim 7, wherein the design pattern is a gate pattern of a transistor and the gate pattern is extracted based on a gate length of the gate pattern.

12. The method according to claim 9, wherein the first circuit element is a logic circuit element and the second circuit element is a memory cell array element.

13. A program allowing a computer to set exposure conditions, comprising:
inputting design layout data;
extracting a plurality of design patterns having a predetermined dimension from the input design layout data;
obtaining a transfer pattern transferred to a transfer target film by exposure of a mask pattern from the mask pattern associated with the extracted patterns, and calculating a dimensional fluctuation amount of the transfer pattern and a design value of the design pattern;
obtaining a distribution of the number of extracted design patterns associated with the dimensional fluctuation amount of the extracted design pattern; and
setting exposure conditions in such a manner that the dimensional fluctuation amount of the extracted design pattern associated with a reference value in the distribution of the number of the design patterns satisfies allowance conditions.

14. The program according to claim 13, wherein obtaining the distribution of the number of design patterns associated with the dimensional fluctuation amount of the design patter includes:
obtaining the distribution of the number of extracted design patterns in accordance with an inter-pattern space of the extracted design pattern and a pattern adjacent thereto; and
obtaining the dimensional fluctuation amount of the extracted design pattern in accordance with the inter-pattern space of the extracted design pattern.

15. The program according to claim 13, further comprising:
changing data associated with a second circuit element in the design layout data in accordance with the set exposure conditions when the design layout data includes data associated with a first circuit element and data associated with the second circuit element and the set exposure conditions are exposure conditions associated with the first circuit element.

16. The program according to claim 13, further comprising:
fabricating a semiconductor integrated circuit corresponding to the design layout data on a semiconductor substrate by using the set exposure conditions.

17. The program according to claim 13, further comprising:
verifying an operation of a circuit corresponding to the design layout data in accordance with each exposure amount by using a error with respect to the inter-pattern space for each gate length used in the design layout data.

18. The program according to claim 17, wherein, in the verification of the circuit operation, the exposure conditions are set in such a manner that at least one of a driving voltage, RC delay, crosstalk noise, signal change noise, signal reflection noise, electromigration, and electromagnetic interference of the circuit pattern satisfies the allowable conditions.

19. The program according to claim 13, wherein the design pattern is a gate pattern of a transistor and the gate pattern is extracted based on a gate length of the gate pattern.

20. The program according to claim 13, wherein the first circuit element is a logic circuit element and the second circuit element is a memory cell array element.
